(19) United States
(12) Patent Application Publication
(10) Pub. No.: US 2024/0372971 A1
(43) Pub. Date: Nov. 7, 2024

(54) INFORMATION PROCESSING APPARATUS, INFORMATION PROCESSING METHOD, DATA STRUCTURE, AND NON-TRANSITORY COMPUTER-READABLE MEDIUM

(71) Applicant: CANON KABUSHIKI KAISHA, Tokyo (JP)

(72) Inventor: HIRONAO ITO, Kanagawa (JP)

(21) Appl. No.: 18/776,427

(22) Filed: Jul. 18, 2024

Related U.S. Application Data
(63) Continuation of application No. PCT/JP2023/001334, filed on Jan. 18, 2023.

(30) Foreign Application Priority Data
Jan. 31, 2022 (JP) 2022-013582

(51) Int. Cl. H04N 13/117; H04N 13/00; H04N 13/167

(52) U.S. Cl. CPC H04N 13/117; H04N 13/167; H04N 2013/0077

(57) ABSTRACT

An information processing apparatus obtains information designating a virtual viewpoint in a frame of a virtual viewpoint video. The apparatus obtains information designating a subject, among a plurality of subjects, to be displayed in the frame of the virtual viewpoint video. The apparatus outputs control information including virtual viewpoint information for specifying the virtual viewpoint for the frame of the virtual viewpoint video and setting information for specifying the subject to be displayed in the frame.

### CROSS-REFERENCE TO RELATED APPLICATIONS

This application is a continuation of International Patent Application No. PCT/JP2023/001334, filed Jan. 18, 2023, which claims the benefit of Japanese Patent Application No. 2022-013582, filed Month Jan. 31, 2022, both of which are hereby incorporated by reference herein in their entirety.

### BACKGROUND

### Field

The present disclosure relates to an information processing apparatus, an information processing method, a data structure, and a non-transitory computer-readable medium, and particularly relates to a technique for generating virtual viewpoint video.

### Description of the Related Art

There is currently increased attention on techniques in which a plurality of image capturing apparatuses are installed at different locations, images are captured synchronously, and virtual viewpoint video is generated using the plurality of images obtained. Such techniques that generate virtual viewpoint video using images from a plurality of viewpoints enable video creators to create compelling content from any viewpoint, using, for example, video obtained by capturing a soccer or basketball game. In this case, the video creator designates the position and orientation of a virtual viewpoint (virtual camera path) that is optimal for generating compelling vidattiteo, based on the scene in the game, e.g., the movement of a player or the ball. Japanese Patent Laid-Open No. 2017-212592 discloses a technique for setting a virtual camera path by operating a device or a UI screen.

### SUMMARY

According to an embodiment, an information processing apparatus comprises one or more memories storing instructions and one or more processors that execute the instructions to: obtain information designating a virtual viewpoint in a frame of a virtual viewpoint video; obtain information designating a subject, among a plurality of subjects, to be displayed in the frame of the virtual viewpoint video; and output control information including virtual viewpoint information for specifying the virtual viewpoint for the frame of the virtual viewpoint video and setting information for specifying the subject to be displayed in the frame.

According to another embodiment, an information processing apparatus comprises one or more memories storing instructions and one or more processors that execute the instructions to: obtain information for designating a virtual viewpoint in a frame of a virtual viewpoint video; obtain information for designating a captured image, among a plurality of captured images obtained by capturing a subject from a plurality of positions, to be used to determine a color of the subject in the frame of the virtual viewpoint video; and output control information including virtual viewpoint information for specifying the virtual viewpoint for the frame of the virtual viewpoint video and setting information for specifying the captured image to be used to determine the color of the subject in the frame.

According to still another embodiment, an information processing apparatus comprises one or more memories storing instructions and one or more processors that execute the instructions to: obtain control information including virtual viewpoint information for specifying a virtual viewpoint in a frame of a virtual viewpoint video and setting information for specifying a subject to be displayed in the frame; and generate a frame image that includes the subject specified by the setting information and that corresponds to the virtual viewpoint specified by the virtual viewpoint information.

According to yet another embodiment, an information processing apparatus comprises one or more memories storing instructions and one or more processors that execute the instructions to: obtain control information including (i) virtual viewpoint information for specifying a virtual viewpoint in a frame of a virtual viewpoint video and (ii) setting information for specifying a captured image, among a plurality of captured images obtained by capturing a subject from a plurality of positions, to be used to determine a color of the subject in the frame; and generate, for the frame of the virtual viewpoint video, a frame image that corresponds to the virtual viewpoint specified by the virtual viewpoint information and that includes the subject, based on the captured image specified by the setting information.

According to still yet another embodiment, an information processing method comprises: obtaining information designating a virtual viewpoint in a frame of a virtual viewpoint video; obtaining information designating a subject, among a plurality of subjects, to be displayed in the frame of the virtual viewpoint video; and outputting control information including virtual viewpoint information for specifying the virtual viewpoint for the frame of the virtual viewpoint video and setting information for specifying the subject to be displayed in the frame.

According to yet still another embodiment, an information processing method comprises: obtaining information for designating a virtual viewpoint in a frame of a virtual viewpoint video; obtaining information for designating a captured image, among a plurality of captured images obtained by capturing a subject from a plurality of positions, to be used to determine a color of the subject in the frame of the virtual viewpoint video; and outputting control information including virtual viewpoint information for specifying the virtual viewpoint for the frame of the virtual viewpoint video and setting information for specifying the captured image to be used to determine the color of the subject in the frame.

According to still yet another embodiment, an information processing method comprises: obtaining control information including virtual viewpoint information for specifying a virtual viewpoint in a frame of a virtual viewpoint video and setting information for specifying a subject to be displayed in the frame; and generating a frame image that includes the subject specified by the setting information and that corresponds to the virtual viewpoint specified by the virtual viewpoint information.

According to yet still another embodiment, an information processing method comprises: obtaining control information including (i) virtual viewpoint information for specifying a virtual viewpoint in a frame of a virtual viewpoint video and (ii) setting information for specifying a captured image, among a plurality of captured images obtained by capturing a subject from a plurality of positions, to be used to determine a color of the subject in the frame; and generating, for the frame of the virtual viewpoint video, a frame image that corresponds to the virtual viewpoint specified by the virtual viewpoint information and that includes the subject, based on the captured image specified by the setting information.

According to still yet another embodiment, a data structure comprises: first data for specifying a virtual viewpoint for a frame of a virtual viewpoint video; and second data for specifying a subject to be displayed from among a plurality of subjects for the frame of the virtual viewpoint video, wherein the data structure is used in processing by an information processing apparatus that generates virtual viewpoint video such that the information processing apparatus specifies a subject from among the plurality of subjects using the second data, and generates a frame image that includes the subject specified and that corresponds to the virtual viewpoint specified by the first data.

According to yet still another embodiment, a data structure comprises: first data for specifying a virtual viewpoint for a frame of a virtual viewpoint video; and second data specifying a captured image, among a plurality of captured images obtained by capturing a subject from a plurality of positions, to be used to determine a color of a subject in the frame of the virtual viewpoint video, wherein the data structure is used in processing by an information processing apparatus that generates virtual viewpoint video such that the information processing apparatus specifies a captured image from among a plurality of captured images using the second data, and generates, based on the captured image specified, a frame image corresponding to the virtual viewpoint specified by the first data.

According to still yet another embodiment, a non-transitory computer-readable medium stores a program executable by a computer to perform a method comprising: obtaining information designating a virtual viewpoint in a frame of a virtual viewpoint video; obtaining information designating a subject, among a plurality of subjects, to be displayed in the frame of the virtual viewpoint video; and outputting control information including virtual viewpoint information for specifying the virtual viewpoint for the frame of the virtual viewpoint video and setting information for specifying the subject to be displayed in the frame.

Further features of the present disclosure will become apparent from the following description of exemplary embodiments with reference to the attached drawings. Note that throughout the accompanying drawings, identical reference numerals denote identical or similar components.

### BRIEF DESCRIPTION OF THE DRAWINGS

The accompanying drawings, which are included in and constitute part of the specification, illustrate embodiments of the present disclosure, and along with those descriptions serve to illustrate the principles of the present disclosure.

FIG. 1 is a diagram illustrating an example of the configuration of a virtual viewpoint image generation system according to one embodiment.

FIG. 2A is a diagram illustrating an example of the format of sequence data including virtual camera path data.

FIG. 2B is a diagram illustrating an example of the format of sequence data including virtual camera path data.

FIG. 3A is a diagram illustrating an example of the format of virtual camera path data.

FIG. 3B is a diagram illustrating an example of the format of virtual camera path data (continuing from FIG. 3A).

FIG. 3C is a diagram illustrating an example of the format of virtual camera path data.

FIG. 4 is a diagram illustrating an example of the format of virtual camera path data.

FIG. 5A is a diagram illustrating a method for generating video according to display subject setting information.

FIG. 5B is a diagram illustrating a method for generating video according to display subject setting information.

FIG. 5C is a diagram illustrating a method for generating video according to display subject setting information.

FIG. 6A is a diagram illustrating a method for generating video according to coloring camera setting information.

FIG. 6B is a diagram illustrating a method for generating video according to coloring camera setting information.

FIG. 6C is a diagram illustrating a method for generating video according to coloring camera setting information.

FIG. 7A is a diagram illustrating a method for generating video according to rendering region setting information.

FIG. 7B is a diagram illustrating a method for generating video according to rendering region setting information.

FIG. 7C is a diagram illustrating a method for generating video according to rendering region setting information.

FIG. 7D is a diagram illustrating a method for generating video according to rendering region setting information.

FIG. 8 is a flowchart illustrating an information processing method according to one embodiment.

FIG. 9 is a diagram illustrating an example of an information processing apparatus according to one embodiment.

FIG. 10 is a flowchart illustrating an information processing method according to one embodiment.

FIG. 11 is a diagram illustrating an example of the hardware configuration of a computer used in one embodiment.

### DESCRIPTION OF THE EMBODIMENTS

Hereafter, embodiments will be described in detail with reference to the attached drawings. Note, the following embodiments are not intended to limit the scope of the claims. Multiple features are described in the embodiments, but limitation is not made to require all such features, and multiple such features may be combined as appropriate. Furthermore, in the attached drawings, the same reference numerals are given to the same or similar configurations, and redundant description thereof is omitted.

According to the technique disclosed in Japanese Patent Laid-Open No. 2017-212592, transitions in the position, orientation, and view angle of a virtual viewpoint are designated as a virtual camera path. However, creating a compelling virtual viewpoint video requires not only simply generating virtual viewpoint video from a virtual viewpoint according to such parameters, but also controlling the generation of the video in more detail.

An embodiment the present disclosure makes it easy to generate a desired virtual viewpoint video.

One embodiment of the present disclosure relates to a technique for generating control information used to generate virtual viewpoint video including a subject from a virtual viewpoint, and a technique for generating virtual viewpoint video including a subject from a virtual viewpoint according to such control information. According to one embodiment, such control information includes setting information related to video generation, and the setting information includes information designating a subject, among a plurality of subjects, to be displayed in each frame of a virtual viewpoint video. Such setting information can be used for settings related to displaying or hiding a specific subject. Such a configuration makes it possible, for example, to perform control that hides one of the plurality of subjects so that a subject behind the hidden subject can be seen. In particular, unlike creating video through CG, when generating virtual viewpoint video based on captured images obtained by a plurality of image capturing apparatuses, it is not easy for the video creator to control the positional relationship of each subject. Accordingly, in virtual viewpoint video seen from a desired virtual viewpoint, the desired subject may be obscured by another subject. However, hiding the other subject using such setting information makes it easy to generate video of the desired subject from any desired viewpoint, which in turn makes it easy to generate compelling virtual viewpoint video.

Furthermore, according to one embodiment, the setting information includes information designating a captured image, from among captured images captured from a plurality of positions, to be used to render a subject in each frame. Such setting information can be used for settings related to an image capturing apparatus used to color a subject. According to such a configuration, the color of the subject in the virtual viewpoint video can be determined, for example, according to the color of the subject as seen from a specific image capturing apparatus. In particular, when generating virtual viewpoint video based on captured images obtained by a plurality of image capturing apparatuses, the desired subject may be obscured by another subject when seen from a given image capturing apparatus. If the color of the subject in the virtual viewpoint video is determined using a captured image captured by such an image capturing apparatus, the reproducibility of the color of the subject may drop. However, appropriately selecting the image capturing apparatus used to color the subject using such setting information makes it easy to reproduce the subject more accurately, which in turn makes it easy to generate compelling virtual viewpoint video.

First, an information processing apparatus that generates control information used to generate virtual viewpoint video including a subject from a virtual viewpoint, according to one embodiment of the present disclosure, will be described. In the following example, the virtual viewpoint video is generated based on a captured image obtained by capturing the subject from a plurality of positions. This control information will be called “virtual camera path data” hereinafter. The virtual camera path data can include information designating a virtual viewpoint in each frame, i.e., time-series information. The control information may, for example, include external parameters such as the position of the virtual viewpoint and a line of sight direction from the virtual viewpoint, and may further include internal parameters such as a view angle corresponding to the field of view from the virtual viewpoint.

The captured image used in the present embodiment can be obtained by a plurality of image capturing apparatuses capturing an image capture region, in which a subject is present, from different directions. The image capture region is a region defined by a plane and a height in, for example, a stadium where a sport such as rugby or soccer is played, for example. The plurality of image capturing apparatuses can be installed at different positions and facing different directions so as to surround such an image capture region, and the image capturing apparatuses capture images in synchronization with each other. Note that the image capturing apparatuses need not be installed across the entire periphery of the image capture region, and may, for example, be installed only in the vicinity of a part of the image capture region in accordance with limitations on installation locations. The number of image capturing apparatuses is not limited. For example, if the image capture region is a rugby stadium, tens to hundreds of image capturing apparatuses may be installed around the stadium.

A plurality of image capturing apparatuses having different view angles, such as telephoto cameras and wide-angle cameras, may also be installed. Using a telephoto camera, for example, makes it possible to capture a subject at a high resolution, which improves the resolution of the generated virtual viewpoint video. Using a wide-angle camera, meanwhile, makes it possible to reduce the number of cameras installed, because the image capturing range of a single camera is wider. The image capturing apparatuses are synchronized using a single item of time information from the real world, and image capturing time information is added to each frame of the video captured by the respective image capturing apparatuses.

Note that a single image capturing apparatus may be constituted by a single camera, or may be constituted by a plurality of cameras. Furthermore, the image capturing apparatus may include an apparatus aside from a camera. For example, the image capturing apparatus may include a ranging apparatus which uses a laser beam or the like.

When generating the virtual viewpoint video, the states of the image capturing apparatuses are referenced. The state of the image capturing apparatus can include the position, the orientation (posture and image capturing direction), the focal length, the optical center, and distortion in the obtained image with respect to the image capturing apparatus. The position and orientation (posture and image capturing direction) of the image capturing apparatus may be controlled by the image capturing apparatus itself, or may be controlled using a gimbal that controls the position and orientation of the image capturing apparatus. Hereinafter, data indicating the state of the image capturing apparatus will be referred to as “camera parameters” of the image capturing apparatus, but the camera parameters may include data indicating a state controlled by another apparatus, such as a gimbal. The camera parameters related to the position and orientation (posture and image capturing direction) of the image capturing apparatus are what are known as “external parameters”. The parameters related to the focal length, image center, and image distortion of the image capturing apparatus are what are known as “internal parameters”. The position and orientation of the image capturing apparatus can be expressed, for example, in a coordinate system having a single origin and three axes orthogonal to each other (called a “world coordinate system” hereinafter).

A virtual viewpoint video is also called a “free viewpoint image”. However, the virtual viewpoint video is not limited to video from a viewpoint that the user designates freely (as desired), and for example, video from a viewpoint selected by the user from a plurality of candidate viewpoints is also included in the virtual viewpoint video. Additionally, the virtual viewpoint may be designated through a user operation, or may be designated automatically based on a result of image analysis or the like. Although the present specification will mainly describe the virtual viewpoint video as being a moving image, the virtual viewpoint video may be a still image.

In the present embodiment, the virtual viewpoint information is information indicating the position and orientation of a virtual viewpoint. Specifically, the virtual viewpoint information includes parameters expressing the three-dimensional position of the virtual viewpoint, and parameters expressing the orientation of the line of sight direction of the virtual viewpoint in the pan, tilt, and roll directions. However, the virtual viewpoint information may include parameters expressing the size (view angle) of the field of view of the virtual viewpoint.

The virtual viewpoint information may be virtual camera path data designating a virtual viewpoint for each of a plurality of frames. In other words, the virtual viewpoint information may include parameters corresponding to each of a plurality of frames constituting the moving image representing the virtual viewpoint video. Such virtual viewpoint information can indicate the position and orientation of the virtual viewpoint at each of a plurality of consecutive points in time.

The virtual viewpoint video is generated through the following method, for example. First, a plurality of captured images are obtained by the image capturing apparatuses capturing images of corresponding image capture regions from different directions. Next, a foreground image extracted from a foreground region corresponding to a subject, such as a person or a ball, and a background image extracted from a background region aside from the foreground region, are obtained from each of the plurality of captured images. The foreground image and the background image have texture information (color information and the like). A foreground model expressing the three-dimensional shape of the subject and texture data for coloring the foreground model are then generated based on the foreground image. The foreground model can be obtained through a shape estimation method such as a visual cone intersection method (shape-from-silhouette), for example. A background model expressing the three-dimensional shape of the background of a stadium or the like can be generated, for example, by measuring the three-dimensional shape of the stadium, a venue, or the like in advance. The texture data used to color the background model can also be generated based on the background image. A virtual viewpoint video is then generated by mapping the texture data onto the foreground model and the background model and rendering an image from the virtual viewpoint indicated by the virtual viewpoint information. However, the method for generating the virtual viewpoint video is not limited to such a method. Various methods can be used, such as, for example, generating virtual viewpoint video through projection conversion of captured images, without using a foreground model and a background model.

Note that a frame image of a single frame of the virtual viewpoint video can be generated using a plurality of captured images captured in synchronization at the same time. A virtual viewpoint video constituted by a plurality of frames can then be generated by generating a frame image for each frame using the captured images at the time corresponding to that frame.

Note that the “foreground image” is an image extracted from a region of the subject (the foreground region) in the captured image captured by the image capturing apparatus. The subject extracted as the foreground region is, for example, a dynamic object exhibiting movement (i.e., the position or shape thereof is variable) when images thereof are captured in time series from the same direction (i.e., a moving object). In the case of a game, the subject may include a person, such as a player or a referee on a field where a game is being played, and may include a ball in addition to the person in the case of a ball-based game, for example. A singer, actor, performer, presenter, or the like in a concert or an entertainment event can also be given as an example of the subject. Note that when a background is registered in advance through a method such as designating a background image, a still subject that is not present in the background is also extracted as the foreground region.

“Background image” refers to an image extracted from a region different from the subject corresponding to the foreground (the background region). For example, the background image may be an image obtained by removing the subject corresponding to the foreground from the captured image. The “background” is a capturing target object which remains stationary or nearly stationary when images are captured in time series from the same direction. Such a capturing target object is, for example, a stage at a concert or the like, a stadium where an event such as a game is held, a structure such as a goal used in a ball-based game, a field, or the like. However, while the background is a region different from the subject, both of the subject and an object different from the background may be present as the capturing target objects.

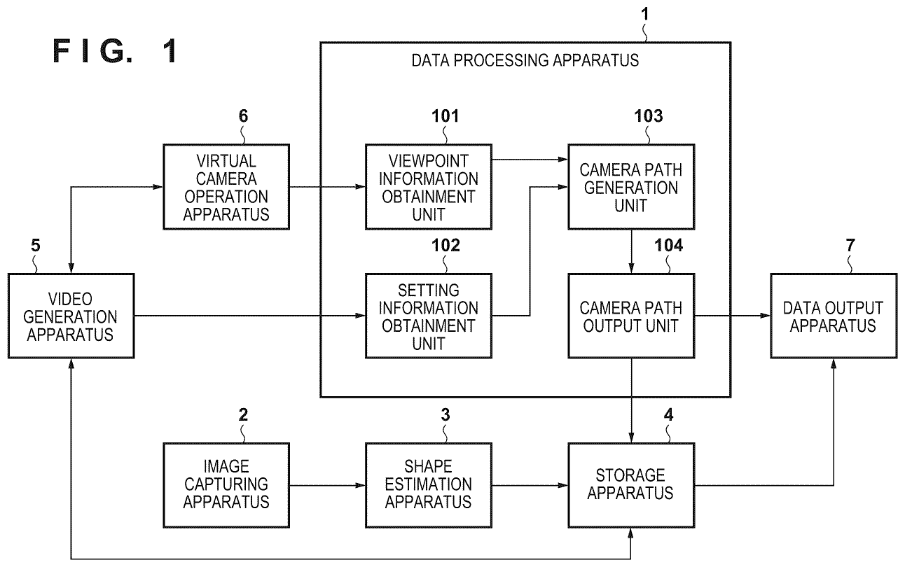

FIG. 1 is a diagram illustrating an example of the configuration of a virtual viewpoint image generation system according to one embodiment of the present disclosure. This system includes a data processing apparatus 1, which is an information processing apparatus according to one embodiment of the present disclosure, as well as an image capturing apparatus 2, a shape estimation apparatus 3, a storage apparatus 4, a video generation apparatus 5, a virtual camera operation apparatus 6, and a data output apparatus 7. FIG. 1 illustrates a single image capturing apparatus 2, and the other image capturing apparatuses are not shown. Additionally, two or more of these apparatuses may be integrated into a single device. For example, the data processing apparatus 1 may have the functions of at least one of the video generation apparatus 5 and the virtual camera operation apparatus 6 described below.

The data processing apparatus 1 generates control information used for generating virtual viewpoint video including a subject from a virtual viewpoint. In FIG. 1, the data processing apparatus 1 is connected to the virtual camera operation apparatus 6, the storage apparatus 4, and the data output apparatus 7. The data processing apparatus 1 also obtains virtual viewpoint information from the virtual camera operation apparatus 6, and obtains setting information related to video generation from the video generation apparatus 5. The data processing apparatus 1 then generates and outputs control information used for generating the virtual viewpoint video based on the obtained virtual viewpoint information and setting information related to video generation. The control information according to the present embodiment is virtual camera path data including virtual viewpoint information for each frame and setting information indicating a video generation method for each frame. The virtual camera path data output by the data processing apparatus 1 is then output to the storage apparatus 4 and the data output apparatus 7.

To generate the virtual viewpoint video, the virtual camera operation apparatus 6 generates virtual viewpoint information designating a virtual viewpoint. The virtual viewpoint is designated by a user (operator) using, for example, an input device such as a joystick, a jog dial, a touch panel, a keyboard, a mouse, or the like. The virtual viewpoint information can include information such as the position, orientation, view angle, and the like of the virtual viewpoint, as well as other information.

Here, the user can designate a virtual viewpoint while viewing a virtual viewpoint video or a frame image generated according to input virtual viewpoint information. To this end, the virtual camera operation apparatus 6 sends the virtual viewpoint information to the video generation apparatus 5. The virtual camera operation apparatus 6 can also receive virtual viewpoint video based on the sent virtual viewpoint information from the video generation apparatus 5 and display the virtual viewpoint video. The user can examine the position and the like of the virtual viewpoint while referring to the virtual viewpoint video displayed in this manner. Note, however, that the method for designating the virtual viewpoint is not limited to the method described above. For example, the virtual camera operation apparatus 6 can also load a virtual camera path file created in advance and designate virtual viewpoints in sequence according to the virtual camera path file. The virtual camera operation apparatus 6 may receive a user input designating movement of the virtual viewpoint and determine the position of the virtual viewpoint in each frame according to the designated movement. On the other hand, information indicating the movement of the virtual viewpoint may be used as the virtual viewpoint information. The virtual camera operation apparatus 6 may also recognize a subject and automatically designate a virtual viewpoint based on a position or the like of the recognized subject.

In addition to the virtual viewpoint information, the virtual camera operation apparatus 6 can also generate setting information related to video generation, which is used to generate the virtual viewpoint video. Such setting information can also be designated by the user using an input device. For example, the virtual camera operation apparatus 6 can present, through a display, for example, a user interface that includes the virtual viewpoint video generated by the video generation apparatus 5 and that accepts the designation of at least one of the virtual viewpoint information or the setting information by the user. The user can designate the virtual viewpoint information or the setting information while viewing a virtual viewpoint video or a frame image generated according to input virtual viewpoint information or setting information. To this end, the virtual camera operation apparatus 6 can send the setting information to the video generation apparatus 5. The virtual camera operation apparatus 6 can also receive virtual viewpoint video based on the sent setting information from the video generation apparatus 5 and display the virtual viewpoint video. The user can examine the setting information while referring to the virtual viewpoint video displayed in this manner. Note that the virtual camera operation apparatus 6 may automatically designate the setting information. For example, the virtual camera operation apparatus 6 can determine whether to display another subject so that a subject of interest is not obscured by the other subject.

As described above, the video generation apparatus 5 can generate virtual viewpoint video in accordance with the virtual viewpoint information. The video generation apparatus 5 may further generate virtual viewpoint video in accordance with the setting information. At this time, the video generation apparatus 5 obtains, from the storage apparatus 4, subject data used when generating the virtual viewpoint video. The subject data can be, for example, a captured image obtained by the image capturing apparatus 2, camera calibration information of the image capturing apparatus 2, point cloud model data, billboard model data, mesh model data, or the like. As will be described later, the subject designated by the virtual camera operation apparatus 6 may correspond to the subject data obtained from the storage apparatus 4. The video generation apparatus 5 can also send the setting information obtained from the virtual camera operation apparatus 6 to the data processing apparatus 1. For example, the video generation apparatus 5 can send the virtual viewpoint video to the virtual camera operation apparatus 6 for display, and send the setting information used for generating the virtual viewpoint video displayed in the virtual camera operation apparatus 6 to the data processing apparatus 1.

The storage apparatus 4 stores the subject data generated by the shape estimation apparatus 3, which has been obtained by the shape estimation apparatus 3. The storage apparatus 4 may be constituted by a semiconductor memory, a magnetic recording device, or the like, for example. Note that each item of subject data stored in the storage apparatus 4 is associated with the image capturing time information of the corresponding subject. The association of the image capturing time information with the subject data can be performed by, for example, adding the image capturing time information to metadata of the subject data. The apparatus that assigns such image capturing time information is not particularly limited, and for example, the image capturing apparatus 2 or the storage apparatus 4 can assign the image capturing time information. The storage apparatus 4 also outputs the subject data in response to requests.

The shape estimation apparatus 3 obtains the captured image or the foreground image from the image capturing apparatus 2, estimates the three-dimensional shape of the subject based on these images, and outputs data of a three-dimensional model representing the three-dimensional shape of the subject. The three-dimensional model is represented by point cloud model data, billboard model data, mesh model data, or the like, as mentioned above. The three-dimensional model may include color information of the subject, in addition to the shape information. Note that if the video generation apparatus 5 generates the virtual viewpoint video without using the foreground model and the background model, the virtual viewpoint image generation system need not include the shape estimation apparatus 3.

The image capturing apparatus 2 has a unique identification number to distinguish that image capturing apparatus 2 from the other image capturing apparatuses 2. The image capturing apparatus 2 may have other functions, such as a function for extracting the foreground image from the captured image obtained by capturing, and may also include hardware (such as circuitry or devices) for implementing such functions.

The data output apparatus 7 receives the virtual camera path data from the data processing apparatus 1, receives the subject data corresponding to the virtual camera path data from the storage apparatus 4, and saves or outputs the input subject data. The format of the data when being saved or output will be described later. Note that the data output apparatus 7 need not output or save the subject data, and the data output apparatus 7 may save or output only the virtual camera path data as sequence data. The data output apparatus 7 may also save or output virtual camera path data of a plurality of patterns, rather than just saving or outputting the virtual camera path data of a single pattern.

The configuration of the data processing apparatus 1 will be described next. The data processing apparatus 1 includes a viewpoint information obtainment unit 101, a setting information obtainment unit 102, a camera path generation unit 103, and a camera path output unit 104.

The viewpoint information obtainment unit 101 performs a viewpoint obtainment operation for obtaining information for designating a virtual viewpoint in a frame of the virtual viewpoint video. The viewpoint information obtainment unit 101 can obtain information designating a virtual viewpoint in each frame. In the present embodiment, the viewpoint information obtainment unit 101 obtains the virtual viewpoint information designated by the virtual camera operation apparatus 6. Note that the viewpoint information obtainment unit 101 may obtain the virtual viewpoint information for all frames at once from the virtual camera operation apparatus 6, or may continually obtain the virtual viewpoint information for each frame sequentially designated through real-time operation of the virtual camera operation apparatus 6.

The setting information obtainment unit 102 performs a setting obtainment operation for obtaining setting information used for generating virtual viewpoint video including a subject from a virtual viewpoint. In the present embodiment, the setting information obtainment unit 102 can obtain information designating a subject, among a plurality of subjects, to be displayed in each frame of the virtual viewpoint video. Additionally, the setting information obtainment unit 102 may obtain information for designating a captured image, among the plurality of captured images obtained by capturing the subject from a plurality of positions, to be used to determine a color of the subject in the frame of the virtual viewpoint video. As described above, the setting information obtainment unit 102 can obtain setting information related to video generation, used by the video generation apparatus 5, from the video generation apparatus 5. Note that like the viewpoint information obtainment unit 101, the setting information obtainment unit 102 can collectively obtain setting information for all frames output by the virtual camera operation apparatus 6. Alternatively, the setting information obtainment unit 102 may continually obtain the virtual viewpoint information for each frame designated sequentially through real-time operation of the virtual camera operation apparatus 6.

The camera path generation unit 103 outputs the control information including the virtual viewpoint information for specifying a virtual viewpoint in a frame of the virtual viewpoint video and setting information for specifying the subject to be displayed in the frame. The camera path generation unit 103 can generate the control information including virtual viewpoint information indicating a virtual viewpoint for each frame and setting information related to video generation (e.g., information indicating the subject to be displayed or information indicating a captured image to be used for rendering) for each frame. In the present embodiment, the camera path generation unit 103 outputs this control information as the virtual camera path data. The virtual camera path data can indicate an association between the information indicating the designated virtual viewpoint and the setting information for each frame. For example, the camera path generation unit 103 can generate the virtual camera path data by adding the control information obtained by the setting information obtainment unit 102 to the virtual viewpoint information obtained by the viewpoint information obtainment unit 101. The camera path generation unit 103 can output the generated control information to the camera path output unit 104.

The camera path output unit 104 outputs the control information including the virtual viewpoint information and the setting information generated by the camera path generation unit 103. As described above, the camera path output unit 104 can output the control information as virtual camera path data. The camera path output unit 104 may add header information or the like to the virtual camera path data before outputting the data. Note that the camera path output unit 104 may output the virtual camera path data as a data file. On the other hand, the camera path output unit 104 may sequentially output a plurality of items of packet data indicating the virtual camera path data. Furthermore, the virtual camera path data may be output in units of frames, in units of virtual camera paths, or in units of a set number of frame groups.

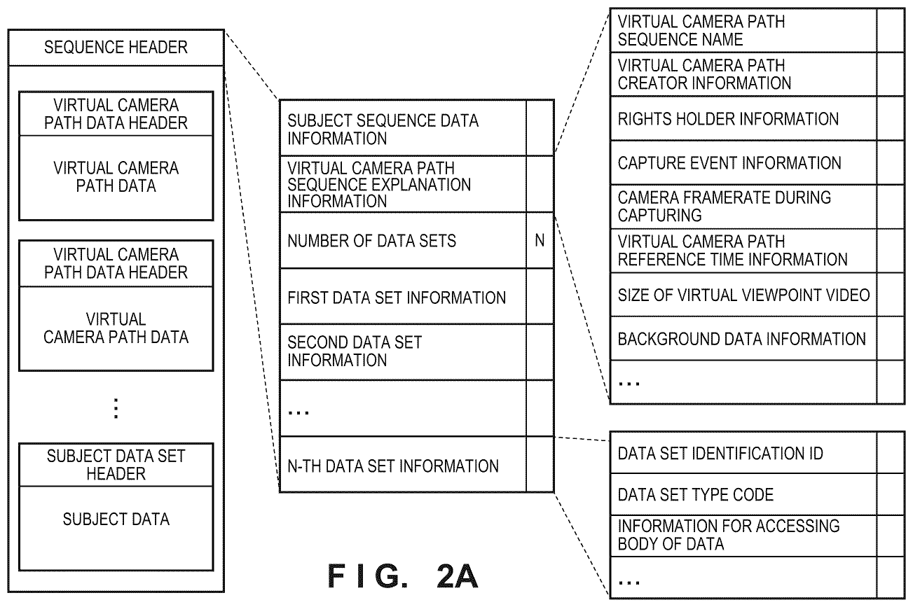

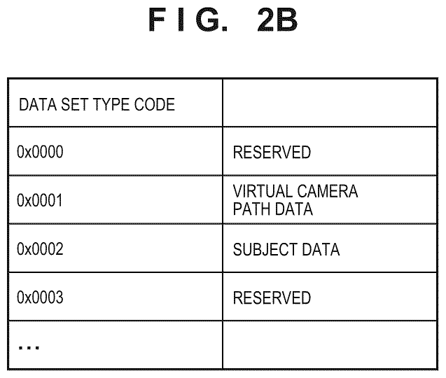

FIG. 2A illustrates an example of the format of the sequence data output by the data output apparatus 7, including the virtual camera path data output by the camera path output unit 104. In FIG. 2A, the virtual camera path data constitutes sequence data indicating the virtual camera path in a single virtual viewpoint video. One item of sequence data may be generated for each video clip or for each capturing cut. Each item of sequence data includes a sequence header, and subject sequence data information specifying the sequence data of the corresponding subject data is saved in the sequence header. The information may be, for example, a sequence header start code capable of uniquely specifying the subject data, information related to the location and the date/time at which the subject was captured, path information expressing the location of the subject data, or the like, but is not limited thereto. The sequence header may also include information indicating that the sequence data includes the virtual camera path data. This information may be information indicating a data set included in the sequence header, or information expressing the presence/absence of the virtual camera path data, for example.

Information related to the sequence data as a whole is saved in the sequence header thereafter. For example, a name of the virtual camera path sequence, information on the creator of the virtual camera path, rights holder information, an event name of an event in which the subject was captured, the camera framerate used during capturing, and time information serving as a reference in the virtual camera path can be saved. The size of the virtual viewpoint video and background data information expected during the rendering of the virtual viewpoint video can also be saved. However, the information saved in the sequence header is not limited thereto.

Each item of virtual camera path data is saved in the sequence data in a unit called a “data set”. A data set number N is saved in the sequence header. In the present embodiment, the sequence data includes two types of data sets, namely the virtual camera path data and the subject data. The information of each data set is saved in a subsequent part of the sequence header.

An identification ID of the data set is saved first in the sequence header as information for one data set. A unique ID is added in all data sets as the identification ID. A type code of the data set is saved thereafter. In the present embodiment, the type code indicates whether the data set expresses the virtual camera path data or the subject data. A two-byte code, as indicated in FIG. 2B, can be used as the type code of the data set. However, the type and code of the data set are not limited thereto. For example, the sequence data may include other types of data used when generating the virtual viewpoint video. A pointer to the data set is saved thereafter. However, other information for accessing the body of the data set may be saved instead of a pointer. For example, a filename in a file system constructed in the storage apparatus 4 may be saved.

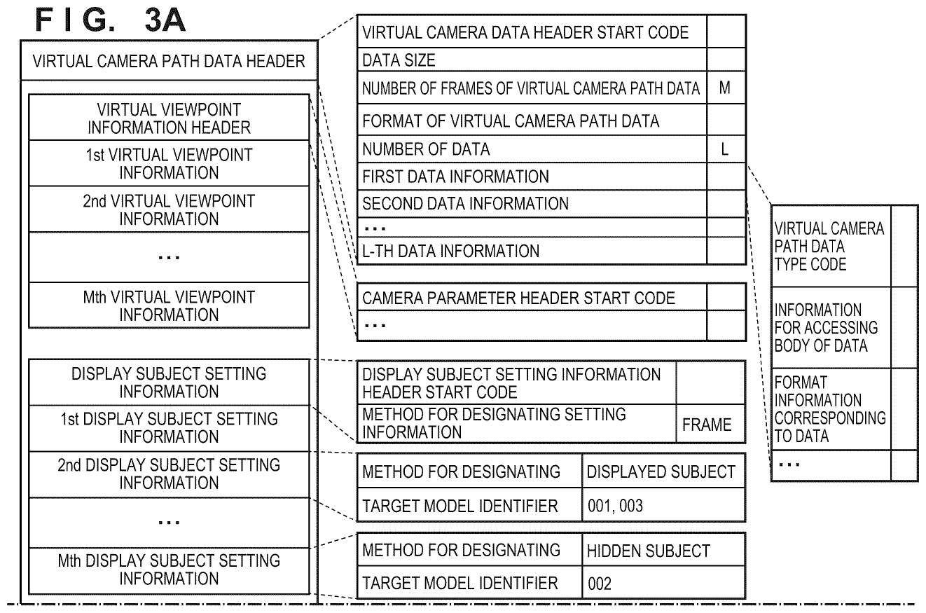

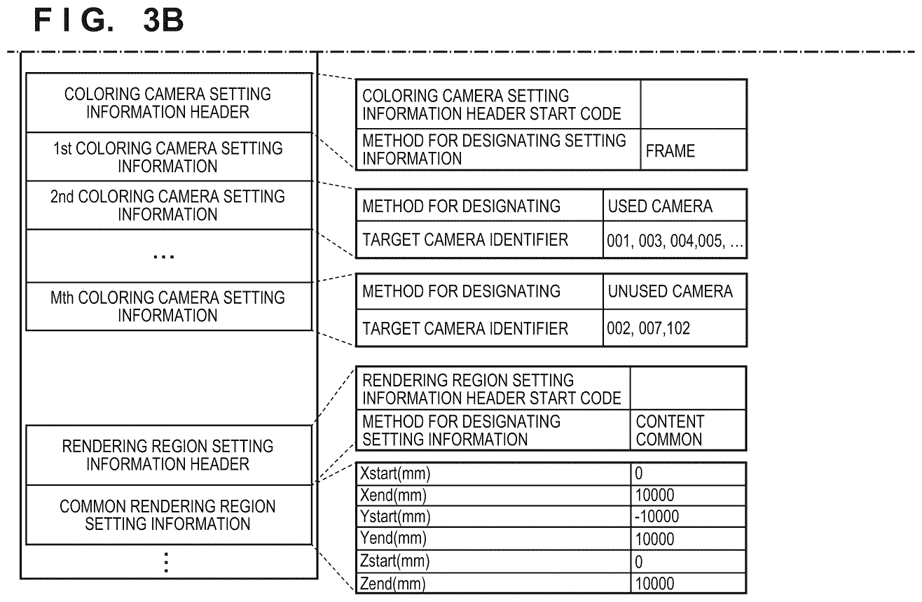

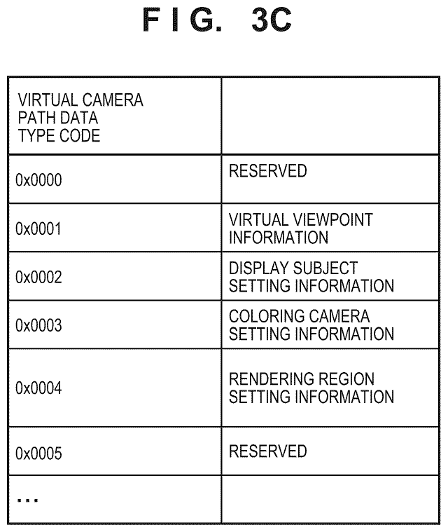

FIGS. 3A and 3B illustrate an example of the configuration of the data set of the virtual camera path data. FIGS. 3A and 3B each illustrates a part of the virtual camera path data, and FIG. 3B is a continuation of FIG. 3A. As described above, the control information according to the present embodiment can include setting information related to the video generation for each frame. The setting information can also include information indicating a subject, among a plurality of subjects, that is displayed in each frame of the virtual viewpoint video. The method for specifying the subject to be displayed is not particularly limited. For example, the setting information may include display subject setting information, which is information indicating whether to display each of the plurality of subjects. The setting information may also include rendering region setting information indicating a region in a three-dimensional space to be rendered, and in this case, a subject located within the region is displayed in the frame image. On the other hand, the setting information may include coloring camera setting information designating a captured image, from among captured images captured from a plurality of positions, to be used to render the subject in each frame. The setting information may also include other types of data used when generating the virtual viewpoint video. For example, the setting information may include additional information aside from the display subject setting information, the coloring camera setting information, and the rendering region setting information. For example, information designating whether to add a shadow to the subject, information indicating the darkness of the shadow, setting information related to the display of a virtual advertisement, effect information, and the like can be given as examples of the additional information. The setting information can include any type of such information.

The virtual camera path data illustrated in FIGS. 3A and 3B includes the display subject setting information, the coloring camera setting information, and the rendering region setting information as the setting information. The virtual camera path data illustrated in FIGS. 3A and 3B also includes the virtual viewpoint information.

A virtual camera path data header is saved at the beginning of the data set. Information indicating that the data set is the data set of the virtual camera path data, and the data size of the data set, are saved at the beginning of the header. A number of frames M of the stored virtual camera path data is denoted thereafter. Additionally, format information of the virtual camera path data is denoted thereafter. This format information is information expressing the format of the stored virtual camera path data, and can indicate, for example, whether various data related to the virtual camera path is stored for each type, or for each frame. In the example illustrated in FIGS. 3A and 3B, each item of data is stored in units of type. In other words, the virtual camera path data includes a plurality of data blocks, the virtual viewpoint information for each frame is included in one data block, and the setting information for each frame is included in another one data block. A number of data Lis denoted in the virtual camera path data header thereafter. The information for each item of data included in the virtual camera path data is saved in the virtual camera path data header thereafter.

A type code of the data is saved first in the information for each item of data in the virtual camera path data header. In the present embodiment, the type of the data is expressed by a virtual camera path data type code. A two-byte code, as indicated in FIG. 3C, for example, can be used as the virtual camera path data type code. However, the type and code of the data are not limited thereto. For example, depending on the information to be described, the code may be a code longer than two bytes or shorter than two bytes, for example. Information for accessing the body of the data, such as a pointer, is saved thereafter. The format information corresponding to the data is denoted thereafter. For example, information indicating that the camera external parameters expressing the position, orientation, and the like of the virtual camera are denoted as a quaternion can be given as an example of the format information for the virtual viewpoint information.

After the virtual camera path data header, actual data (the data body) of each item of data related to the virtual camera path is denoted as the virtual camera path data, in accordance with the format described in the virtual camera path data header. A start code expressing the start of the data is denoted at the beginning of each item of data. In the example illustrated in FIGS. 3A and 3B, the virtual viewpoint information, the display subject setting information, the coloring camera setting information, and the rendering region setting information are denoted in that order as the body of the data. Information on each of first to Mth frames is also included in the corresponding data. The virtual viewpoint information can include information designating the virtual viewpoint in each frame, and for example, the internal parameters and/or the external parameters can be denoted. In one embodiment, the virtual viewpoint information includes external parameters indicating the position of the virtual viewpoint and the line of sight direction from the virtual viewpoint. Additionally, in one embodiment, the virtual viewpoint information includes the internal parameters indicating the view angle or the focal length of the virtual viewpoint.

The display subject setting information is information indicating whether or not to display each of the plurality of subjects. Here, a subject to be displayed or a subject not to be displayed can be designated using an identifier of the model of that subject. FIGS. 3A and 3B illustrate an example in which a method for designating a subject to be displayed is used, and model identifiers 001 and 003 of subjects to be displayed are designated, as well as an example in which a method for designating a subject not to be displayed is employed, and a model identifier 002 of a subject not to be displayed is designated. In both examples, the subject specified by the model identifier 002 is not displayed in the virtual viewpoint video. A unique identifier capable of uniquely specifying the three-dimensional model in a single frame can be used to designate the subject. Such an identifier may be defined for each frame, or the same identifier may be used for the same subject in a content data group.

The coloring camera setting information is information for specifying a captured image to be used to determine the color of a subject in a frame of the virtual viewpoint image. This information can indicate a captured image to be used to render the subject in each frame of the virtual viewpoint video, and more specifically, can indicate a captured image to be referenced to determine the color of the subject in the frame image of each frame. Such information makes it possible to control the selection of an image capturing apparatus to be used to color the subject or a three-dimensional model thereof. In the example illustrated in FIGS. 3A and 3B, an image capturing apparatus that is or is not used for coloring is designated. The image capturing apparatus to be designated can be designated using a unique identifier capable of uniquely specifying that image capturing apparatus. Such an image capturing apparatus identifier can be determined when constructing an image generation system, and in this case, the same identifier is used for the same image capturing apparatus in the content data group. However, the image capturing apparatus identifier may be defined for each frame. For example, several tens to several hundreds of image capturing apparatuses are used when generating virtual viewpoint video, and thus using a method which designates image capturing apparatuses not used for coloring may make it possible to reduce the burden on the user.

The rendering region setting information is information indicating a region in the three-dimensional space for which the virtual viewpoint video is to be generated (or rendered). A subject located within the region set here can be displayed in each frame. For example, a coordinate range can be designated, and in this case, a three-dimensional model not present in the designated coordinate range is not rendered, i.e., is not displayed in the virtual viewpoint video. The range can be designated, for example, using a coordinate system that defines a three-dimensional model, e.g., x, y, and z coordinates according to world coordinates. However, the method for setting the region is not particularly limited, and for example, settings may be made such that all subjects for which the x coordinate and the z coordinate are within a predetermined range are rendered.

This setting information may be denoted for each frame. In other words, in one embodiment, the virtual viewpoint information and the setting information are recorded on a frame-by-frame basis in the virtual camera path data. On the other hand, common setting information may be used for the entirety of the content represented by the sequence data (e.g., for all frames), or for only some of the content (e.g., for a plurality of frames). In other words, setting information applied in common to a plurality of frames may be recorded in the virtual camera path data. Whether to denote different setting information for each frame or to denote setting information common for all frames can be determined for each type of data. For example, in the example illustrated in FIGS. 3A and 3B, the display subject setting information and the coloring camera setting information are designated on a frame-by-frame basis, and the rendering region setting information is used in common for the entirety of the content. On the other hand, display subject setting information or coloring camera setting information common to the entirety of the content may be designated.

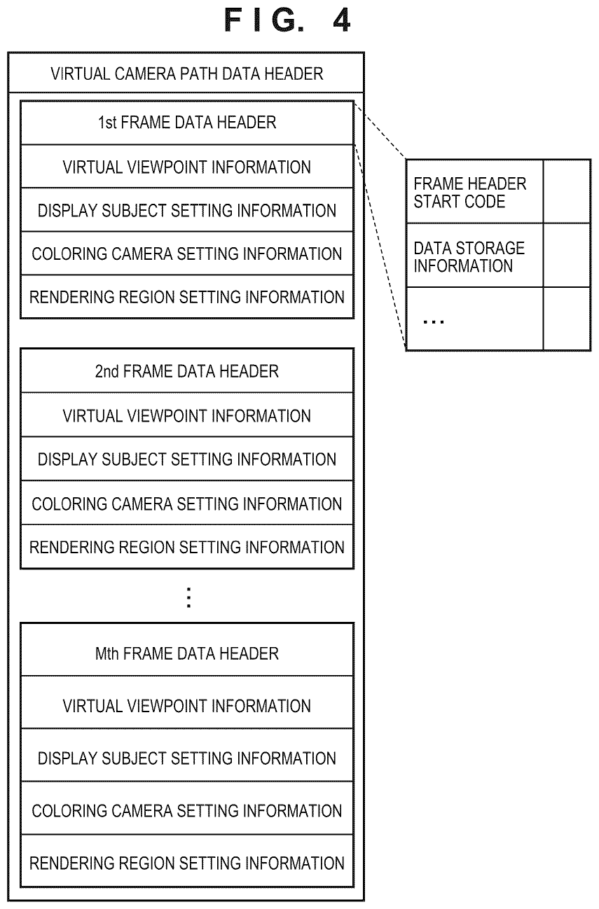

FIG. 4 illustrates an example of the virtual camera path data when various data related to the virtual camera path is stored on a frame-by-frame basis. In this manner, the virtual camera path data may include a plurality of data blocks, and the virtual viewpoint information and the setting information for one frame are included in one data block. When the data is stored on a frame-by-frame basis, a frame data header is added at the beginning of each item of frame data. The frame data header can include a code expressing that the frame data is to be started, and information indicating the type of data to be stored as the frame data and the order thereof.

Control of the virtual viewpoint video using the display subject setting information, the coloring camera setting information, and the rendering region setting information will be described in detail hereinafter.

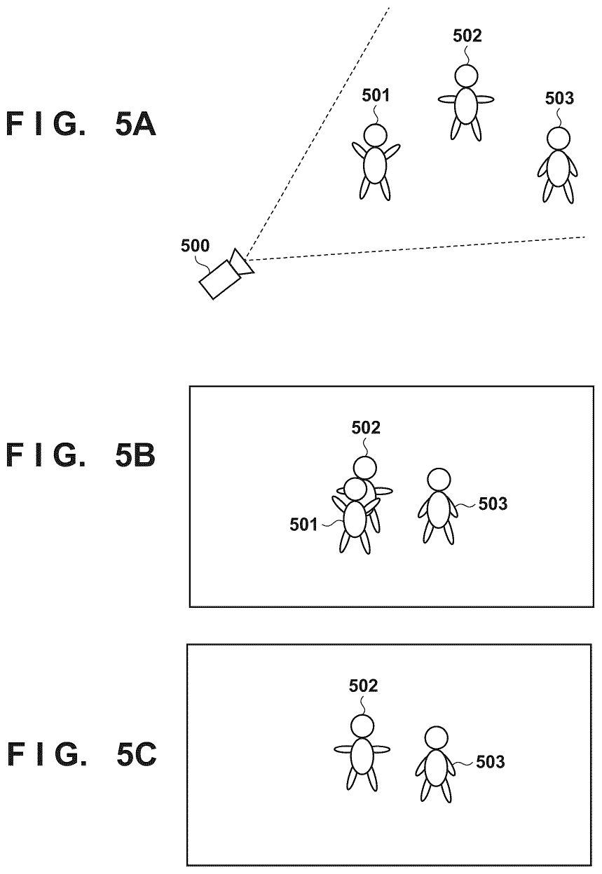

FIGS. 5A to 5C illustrate an example of control performed using the display subject setting information. FIG. 5A illustrates a three-dimensional model of subjects 501, 502, and 503 obtained by capturing a space in which the subjects are present, and a virtual viewpoint 500 designated for generating virtual viewpoint video. Here, when the virtual viewpoint video is generated according to the three-dimensional models of the subjects 501 to 503, the subjects 501 to 503 are displayed in the virtual viewpoint video as illustrated in FIG. 5B. Here, when the virtual viewpoint video is generated having designated the three-dimensional model of the subject 501 as a hidden subject, the subject 501 is not displayed in the virtual viewpoint video, and the subject 502 can therefore be seen, as illustrated in FIG. 5C.

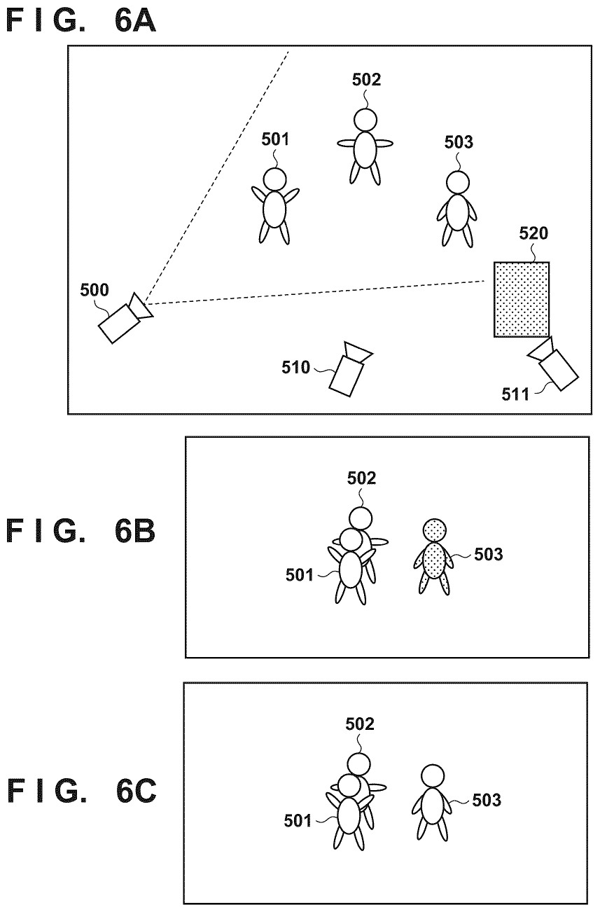

FIGS. 6A to 6C illustrate an example of control performed using the coloring camera setting information. FIG. 6A illustrates a space in which subjects are present, and illustrates image capturing apparatuses 510 and 511 and an obstruction 520. It is assumed that the virtual viewpoint video illustrated in FIG. 6B is obtained by generating the three-dimensional models of the subjects 501 to 503 using captured images obtained by the image capturing apparatuses and other image capturing apparatuses (not shown), and generating virtual viewpoint video from the virtual viewpoint 500. In FIG. 6B, the subject 503 is given a texture based on a captured image captured by the image capturing apparatus 511 that is close to the subject 503, but the color of the subject 503 is different from the original subject due to the unexpected obstruction 520. Here, the virtual viewpoint video illustrated in FIG. 6C is obtained when the image capturing apparatus 511 is excluded from the image capturing apparatuses used for coloring by the coloring camera control. In FIG. 6C, a texture based on a captured image captured by the image capturing apparatus 510 is added to the subject 502, and the subject 502 is displayed with the correct color.

Note that there are various algorithms for selecting an image capturing apparatus to be used for coloring a subject, and it is conceivable to select, for example, an image capturing apparatus located closer to the virtual viewpoint, an image capturing apparatus having a line of sight direction which is closer to that of the virtual viewpoint, an image capturing apparatus located closer to the subject, or the like. Using such coloring camera setting information makes it possible to limit the cameras that can be selected when rendering a subject. According to this method, measures can be taken for obstructions such as those illustrated in FIG. 6A, and particularly obstructions that are present in a position where three-dimensional modeling is not performed. In addition, this method can be used to generate virtual viewpoint video showing a subject while moving the virtual viewpoint around the subject at the same time, which makes it possible to alleviate discomfort caused by switching the camera for rendering the subject.

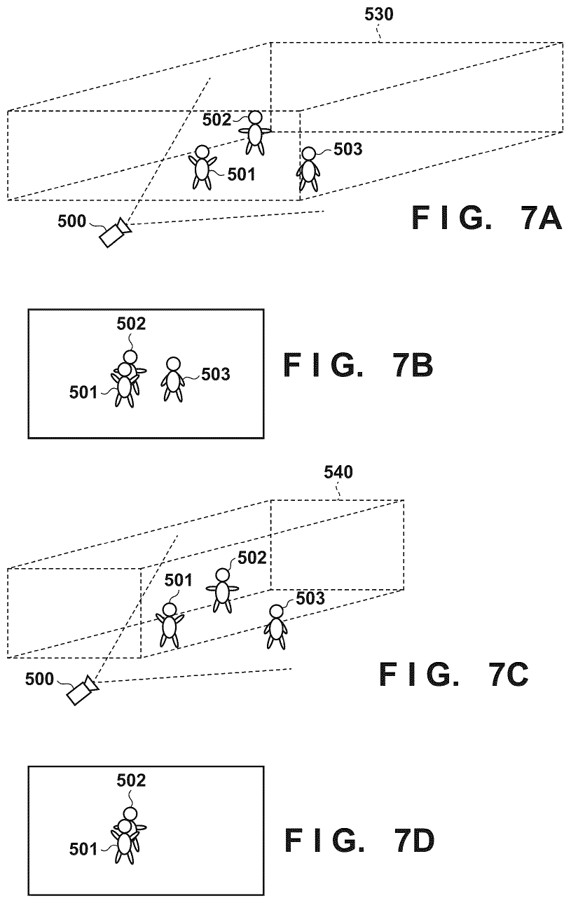

FIGS. 7A to 7D illustrate an example of control performed using the rendering region setting information. FIG. 7A illustrates a three-dimensional model of the subjects 501, 502, and 503 obtained by capturing a space in which the subjects are present, and a rendering region 530 designated for generating virtual viewpoint video. The rendering region 530 illustrated in FIG. 7A is the entire space that can be designated by the system. In this case, as illustrated in FIG. 7B, all the three-dimensional models are displayed in the generated virtual viewpoint video. On the other hand, FIG. 7C illustrates an example of a case where a rendering region 540 that is about half the size of the rendering region 530 is designated. In this case, because the three-dimensional model of the subject 503 is outside the rendering region, the subject 503 is not displayed in the virtual viewpoint video, as illustrated in FIG. 7D. The same effects as those of the aforementioned subject display control can be achieved by controlling the rendering region in such a manner. Additionally, according to such a configuration, when only a part of the three-dimensional model is present in the region, only that part is displayed.

In this manner, the data structure according to one embodiment, such as the virtual camera path data, includes first data for specifying a virtual viewpoint for a frame of a virtual viewpoint video, e.g., the virtual viewpoint information. The data structure according to one embodiment also includes second data for specifying a subject to be displayed from among a plurality of subjects for a frame of the virtual viewpoint video, e.g., the display subject setting information or the rendering region setting information. Then, such a data structure is used in processing by which an information processing apparatus that generates virtual viewpoint video specifies a subject from a plurality of subjects using the second data. In addition, such a data structure is used in processing that generates a frame image that includes the specified subject and that corresponds to the virtual viewpoint specified by the first data. On the other hand, the data structure according to one embodiment includes the second data specifying a captured image, among a plurality of captured images obtained by capturing a subject from a plurality of positions, to be used to determine a color of a subject in the frame of the virtual viewpoint video. The above-described coloring camera setting information is an example of the second data. Then, such a data structure is used in processing by which an information processing apparatus that generates virtual viewpoint video specifies a captured image from a plurality of captured images using the second data. In addition, such a data structure is used in processing that generates a frame image corresponding to the virtual viewpoint specified by the first data, based on the specified captured image.

It should be noted that the sequence data illustrated in FIG. 2A includes two data sets, namely the virtual camera path data and the subject data. However, the method for saving the virtual camera path data and the subject data is not limited to such a method. For example, only the virtual camera path data may be included in the sequence data. In this case, the subject data may be stored in the storage apparatus 4 separately from the virtual camera path data (or the sequence data).

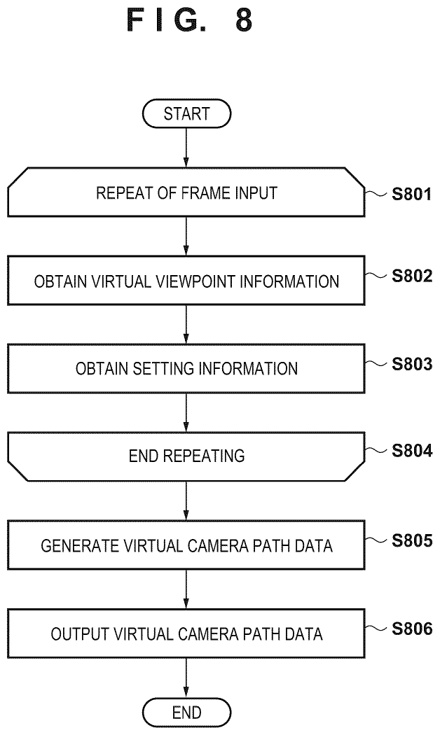

An example of an information processing method performed by the data processing apparatus 1 described above will be described next with reference to the flowchart in FIG. 8. The processing of S801 to S804 is repeated on a frame-by-frame basis, from the start of the virtual camera path until the virtual camera path or the input in units of frames ends. For example, the following processing can be repeated from the frame in which the user starts to set the virtual camera path to the frame in which that setting ends.

In S802, the viewpoint information obtainment unit 101 obtains virtual viewpoint information indicating a virtual viewpoint for the frame to be processed from the virtual camera operation apparatus 6. In S803, the setting information obtainment unit 102 obtains the aforementioned setting information related to video generation for the frame to be processed from the video generation apparatus 5.

In S805, the camera path generation unit 103 generates control information including the virtual viewpoint information for each frame obtained by the viewpoint information obtainment unit 101 and the setting information for each frame obtained by the setting information obtainment unit 102. For example, the camera path generation unit 103 can generate the virtual camera path data by adding the setting information to the virtual viewpoint information.

In S806, the camera path output unit 104 outputs the control information generated by the camera path generation unit 103. For example, the camera path output unit 104 can output the virtual camera path data after adding header information or the like to the virtual camera path data.

According to the present embodiment, as described above, control information including virtual viewpoint information indicating a virtual viewpoint for each frame and setting information related to video generation for each frame can be generated. In particular, in the present embodiment, both the virtual viewpoint information and the above-described setting information are added to the virtual camera path data, and thus as described above, the degree of freedom of the control for generating the virtual viewpoint video can be increased, which makes it easy to generate the desired virtual viewpoint video.

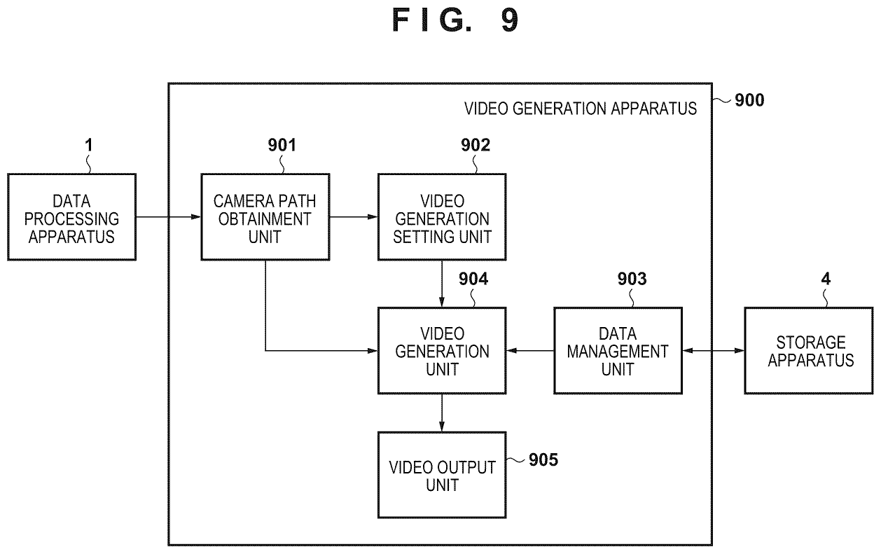

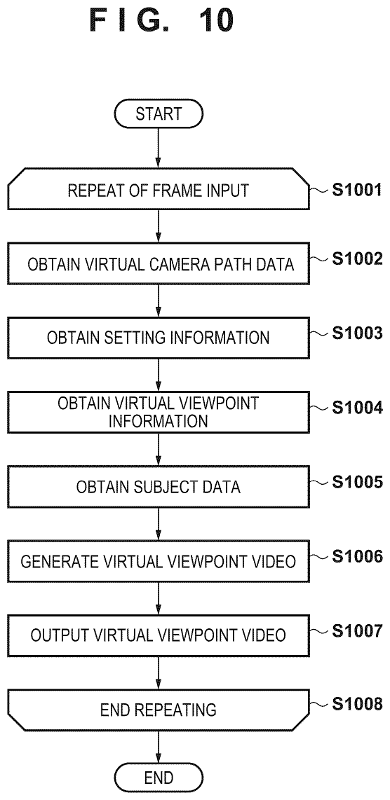

A method for generating virtual viewpoint video in accordance with such control information generated by the data processing apparatus 1 will be described next. FIG. 9 illustrates an example of the configuration of a system that includes a video generation apparatus that is an information processing apparatus according to one embodiment of the present disclosure. A video generation apparatus 900 generates virtual viewpoint video including a subject from a virtual viewpoint. This video generation apparatus 900 can generate the virtual viewpoint video based on a captured image obtained by capturing the subject from a plurality of positions. Note that the configurations of the data processing apparatus 1 and the storage apparatus 4 are as described earlier.

The video generation apparatus 900 includes a camera path obtainment unit 901, a video setting unit 902, a data management unit 903, a video generation unit 904, and a video output unit 905.

The camera path obtainment unit 901 obtains control information including virtual viewpoint information for specifying a virtual viewpoint for a frame of a virtual viewpoint video and setting information related to video generation for each frame. The camera path obtainment unit 901 can obtain virtual camera path data including such control information output by the data processing apparatus 1 described above. Note that as described above, the setting information may be information for specifying a subject to be displayed in a frame of the virtual viewpoint video. Additionally, the setting information may be information for specifying a captured image, among a plurality of captured images obtained by capturing the subject from a plurality of positions, to be used to determine a color of the subject in the frame of the virtual viewpoint video.

Although the video generation apparatus 900 is connected to the data processing apparatus 1 in FIG. 9, the video generation apparatus 900 may obtain the virtual camera path data from a storage medium. For example, the virtual camera path data from the data processing apparatus 1 may be input to the camera path obtainment unit 901 as a data file, or may be input as packet data. Note that the camera path obtainment unit 901 may obtain the virtual camera path data for each frame, for each set number of frame groups, or for each of one or more data sets of the virtual camera path data. When a plurality of data sets of the virtual camera path data are obtained, the video output unit 905 can output the virtual viewpoint video corresponding to the respective virtual camera path data sets separately. Note that the data sets of the respective virtual camera paths can be distinguished by the identification IDs denoted in respective virtual camera path data set headers.

The video setting unit 902 obtains the above-described setting information used for generating the virtual viewpoint video from the virtual camera path data obtained by the camera path obtainment unit 901. The video setting unit 902 then sets the video generation method used by the video generation unit 904 based on the obtained setting information.

The data management unit 903 obtains the subject data corresponding to the virtual camera path based on a request from the video generation unit 904. In FIG. 9, the video generation apparatus 900 is connected to the storage apparatus 4, and the data management unit 903 can obtain the subject data from the storage apparatus 4. Alternatively, the video generation apparatus 900 may obtain the subject data from a storage medium. For example, the data management unit 903 can obtain the subject data included in the sequence data output by the data output apparatus 7. Furthermore, the video generation apparatus 900 may store the same data as the subject data stored in the storage apparatus 4.

Note that the subject data obtained by the data management unit 903 is selected based on the method by which the video generation unit 904 generates the virtual viewpoint video. For example, when a video generation method based on a foreground model or a background model is used, the data management unit 903 can obtain point cloud model data or mesh model data of the foreground or the background. The data management unit 903 can also obtain texture images corresponding to the models, captured images for generating textures, camera calibration data, and the like. On the other hand, when a video generation method that does not use a foreground model or a background model is used, the data management unit 903 can obtain captured images, camera calibration data, and the like.

Based on the setting information, the video generation unit 904 generates a virtual viewpoint video by generating a frame image from a virtual viewpoint indicated by the virtual viewpoint information for each frame of the virtual viewpoint video. In the present embodiment, the video generation unit 904 generates the virtual viewpoint video using the virtual viewpoint information obtained by the camera path obtainment unit 901 and the subject data obtained by the data management unit 903. Here, the video generation unit 904 generates virtual viewpoint video in accordance with the video generation method set by the video setting unit 902. As described above, the video generation unit 904 can generate a frame image that includes the subject specified by the setting information and that corresponds to the virtual viewpoint specified by the virtual viewpoint information, in accordance with the setting information for specifying the subject to be displayed in the frame. Additionally, the video generation unit 904 can generate, for the frame of the virtual viewpoint video, a frame image that corresponds to the virtual viewpoint specified by the virtual viewpoint information and that includes the subject, based on the captured image specified by the setting information. The video generation method based on the setting information is as described earlier with reference to FIGS. 5A to 7D.

The video output unit 905 obtains the virtual viewpoint video from the video generation unit 904 and outputs the virtual viewpoint video to a display device such as a display. Note that the video output unit 905 may output the virtual viewpoint video obtained from the video generation unit 904 as a data file or packet data.

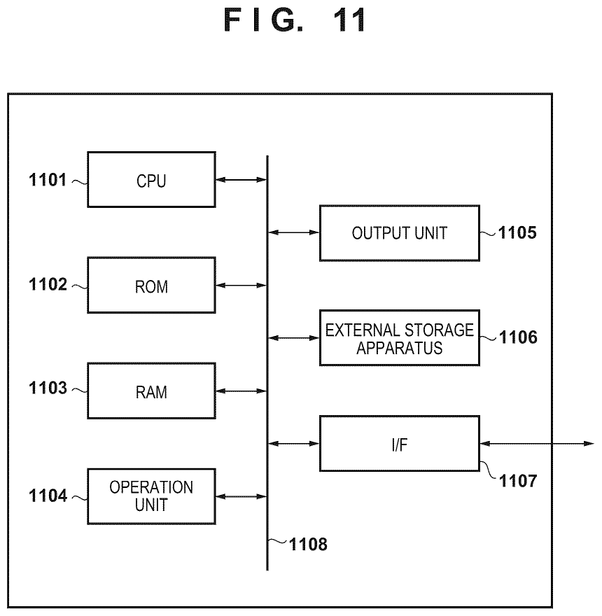

An information processing method performed by the information processing apparatus according to the present embodiment will be described with reference to the flowchart in FIG. 10. The processing of S1001 to S1008 is repeated on a frame-by-frame basis, from the start to the end of the virtual camera path.

In S1002, for the frame to be processed, the camera path obtainment unit 901 obtains the control information including the virtual viewpoint information indicating a virtual viewpoint and the above-described setting information related to video generation. For example, the camera path obtainment unit 901 can obtain information related to the frame to be processed, which is included in the virtual camera path data obtained from the data processing apparatus 1. The setting information is as described earlier.

In S1003, the video setting unit 902 obtains the setting information from the camera path obtainment unit 901 and sets the video generation unit 904 to perform operations according to the setting information. In step S1004, the video generation unit 904 obtains the virtual viewpoint information from the camera path obtainment unit 901. In S1005, the data management unit 903 obtains the subject data from the storage apparatus 4 in accordance with a request from the video generation unit 904.

In S1006, for the frame to be processed, the video generation unit 904 generates a frame image from the virtual viewpoint indicated by the virtual viewpoint information, in accordance with the setting information. The video generation unit 904 can, in accordance with the settings designated in S1003, generate the virtual viewpoint video based on the subject data obtained in S1005 and the virtual viewpoint information obtained in S1004. The method for generating an image according to the setting information is as described earlier. In S1007, the video output unit 905 outputs the frame image of the virtual viewpoint video generated in step S1006 through a display device such as a display. The video output unit 905 may output the frame image of the virtual viewpoint video as a data file or packet data.

According to the present embodiment described above, the virtual viewpoint video can be generated based on control information including virtual viewpoint information indicating a virtual viewpoint for each frame and setting information related to video generation for each frame. Using such setting information increases the degree of freedom of control in generating the virtual viewpoint video, which makes it easy to output compelling virtual viewpoint video.

In addition, the setting information can be recorded in the control information, such as the above-described virtual camera path data, which makes it easy for the user to create the control information and correct the virtual viewpoint information or the setting information after viewing the virtual viewpoint video according to the control information. Furthermore, by sending such control information created by the video creator to a viewer along with the subject data, the viewer can view virtual viewpoint video recommended by the video creator according to the control information. On the other hand, the viewer can also select whether to view the virtual viewpoint video according to the control information, or to view the virtual viewpoint video from a desired viewpoint without using the control information.

Each information processing apparatus described above, such as the data processing apparatus 1 and the video generation apparatus 900, can be realized by a computer including a processor and a memory. However, some or all of the functions of each information processing apparatus may be implemented by dedicated hardware. Additionally, an image processing apparatus according to one embodiment of the present disclosure may be constituted by a plurality of information processing apparatuses connected over a network, for example.

FIG. 11 is a block diagram illustrating an example of the hardware configuration of such a computer. A CPU 1101 controls the computer as a whole using computer programs, data, and the like stored in a RAM 1102, a ROM 1103, and the like, and executes the processing described above as processing performed by an information processing apparatus according to the foregoing embodiment. In other words, the CPU 1101 can function as the processing units illustrated in FIGS. 1 and 9.

The RAM 1102 is a memory having an area for temporarily storing computer programs, data, and the like loaded from an external storage apparatus 1106, data obtained from the exterior via an I/F (interface) 1107, and the like. The RAM 1102 further has a work area used by the CPU 1101 when executing various processes. In other words, the RAM 1102 can provide a frame memory and various other types of areas, for example.

The ROM 1103 is a memory storing configuration data, a boot program, and the like for the computer. An operation unit 1104 is an input device such as a keyboard, a mouse, or the like, and can input various types of instructions to the CPU 1101 by being operated by a user of the computer. An output unit 1105 is an output device that outputs results of processing performed by the CPU 1101, and is a display device such as a liquid crystal display, for example.

The external storage apparatus 1106 is a high-capacity information storage apparatus such as a hard disk drive apparatus. The external storage apparatus 1106 can store an OS (operating system), computer programs for causing the CPU 1101 to implement the functions of each unit illustrated in FIG. 1, and the like. Captured image data captured by the image capturing apparatus 2, the virtual viewpoint video data generated by the video generation apparatus 5, or the like may also be stored in the external storage apparatus 1106.

The computer programs, data, and the like stored in the external storage apparatus 1106 are loaded into the RAM 1102 as appropriate under the control of the CPU 1101, and are then processed by the CPU 1101. Networks such as LANs and the Internet, other devices such as projection apparatuses and display apparatuses, and the like can be connected to the I/F 1107, and the computer can obtain and send various information via this I/F 1107. 1108 indicates a bus that connects the aforementioned units to each other.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

1. An information processing apparatus comprising one or more memories storing instructions and one or more processors that execute the instructions:
to obtain information designating a virtual viewpoint in a frame of a virtual viewpoint video;
to obtain information designating a subject, among a plurality of subjects, to be displayed in the frame of the virtual viewpoint video; and
to output control information including virtual viewpoint information for specifying the virtual viewpoint for the frame of the virtual viewpoint video and setting information for specifying the subject to be displayed in the frame.

2. The information processing apparatus according to claim 1, wherein the setting information is information indicating whether or not to display each of the plurality of subjects.

3. The information processing apparatus according to claim 1, wherein the setting information is information indicating a region in a three-dimensional space of which virtual viewpoint video is to be generated, and a subject positioned within the region is displayed.

4. An information processing apparatus comprising one or more memories storing instructions and one or more processors that execute the instructions:
to obtain information for designating a virtual viewpoint in a frame of a virtual viewpoint video;
to obtain information for designating a captured image, among a plurality of captured images obtained by capturing a subject from a plurality of positions, to be used to determine a color of the subject in the frame of the virtual viewpoint video; and
to output control information including virtual viewpoint information for specifying the virtual viewpoint for the frame of the virtual viewpoint video and setting information for specifying the captured image to be used to determine the color of the subject in the frame.

5. The information processing apparatus according to claim 1, wherein the virtual viewpoint information includes an external parameter indicating a position of the virtual viewpoint and a line of sight direction from the virtual viewpoint.

6. The information processing apparatus according to claim 1, wherein the virtual viewpoint information includes an internal parameter indicating a view angle or a focal length of the virtual viewpoint.

7. The information processing apparatus according to claim 1, wherein the one or more processors execute the instructions to output the control information as virtual camera path data, and the virtual viewpoint information and the setting information are recorded on a frame-by-frame basis in the virtual camera path data.

8. The information processing apparatus according to claim 1, wherein the one or more processors execute the instructions to output the control information as virtual camera path data, and the setting information is recorded in the virtual camera path data, wherein the setting information is to be applied in common to a plurality of frames.

9. The information processing apparatus according to claim 7, wherein the virtual camera path data includes a plurality of data blocks, and the virtual viewpoint information and the setting information for one frame are included in one data block.

10. The information processing apparatus according to claim 1, wherein the one or more processors execute the instructions:
to generate the virtual viewpoint video based on the virtual viewpoint information and the setting information; and
to present a user interface that includes the virtual viewpoint video generated and that accepts a designation of at least one of the virtual viewpoint information or the setting information by a user.

11. An information processing apparatus comprising one or more memories storing instructions and one or more processors that execute the instructions:
to obtain control information including virtual viewpoint information for specifying a virtual viewpoint in a frame of a virtual viewpoint video and setting information for specifying a subject to be displayed in the frame; and
to generate a frame image that includes the subject specified by the setting information and that corresponds to the virtual viewpoint specified by the virtual viewpoint information.

12. An information processing apparatus comprising one or more memories storing instructions and one or more processors that execute the instructions:
to obtain control information including (i) virtual viewpoint information for specifying a virtual viewpoint in a frame of a virtual viewpoint video and (ii) setting information for specifying a captured image, among a plurality of captured images obtained by capturing a subject from a plurality of positions, to be used to determine a color of the subject in the frame; and
to generate, for the frame of the virtual viewpoint video, a frame image that corresponds to the virtual viewpoint specified by the virtual viewpoint information and that includes the subject, based on the captured image specified by the setting information.

13. The information processing apparatus according to claim 11, wherein the one or more processors execute the instructions:
to obtain virtual camera path data indicating the control information; and
to generate the virtual viewpoint video using subject data representing the subject, the subject data being stored in a storage device separately from the virtual camera path data.

14. An information processing method comprising:
obtaining information designating a virtual viewpoint in a frame of a virtual viewpoint video;
obtaining information designating a subject, among a plurality of subjects, to be displayed in the frame of the virtual viewpoint video; and
outputting control information including virtual viewpoint information for specifying the virtual viewpoint for the frame of the virtual viewpoint video and setting information for specifying the subject to be displayed in the frame.

15. An information processing method comprising:
obtaining information for designating a virtual viewpoint in a frame of a virtual viewpoint video;
obtaining information for designating a captured image, among a plurality of captured images obtained by capturing a subject from a plurality of positions, to be used to determine a color of the subject in the frame of the virtual viewpoint video; and
outputting control information including virtual viewpoint information for specifying the virtual viewpoint for the frame of the virtual viewpoint video and setting information for specifying the captured image to be used to determine the color of the subject in the frame.

16. An information processing method comprising:
obtaining control information including virtual viewpoint information for specifying a virtual viewpoint in a frame of a virtual viewpoint video and setting information for specifying a subject to be displayed in the frame; and
generating a frame image that includes the subject specified by the setting information and that corresponds to the virtual viewpoint specified by the virtual viewpoint information.

17. An information processing method comprising:
obtaining control information including (i) virtual viewpoint information for specifying a virtual viewpoint in a frame of a virtual viewpoint video and (ii) setting information for specifying a captured image, among a plurality of captured images obtained by capturing a subject from a plurality of positions, to be used to determine a color of the subject in the frame; and
generating, for the frame of the virtual viewpoint video, a frame image that corresponds to the virtual viewpoint specified by the virtual viewpoint information and that includes the subject, based on the captured image specified by the setting information.

18. A data structure comprising:
first data for specifying a virtual viewpoint for a frame of a virtual viewpoint video; and
second data for specifying a subject to be displayed from among a plurality of subjects for the frame of the virtual viewpoint video,
wherein the data structure is used in processing by an information processing apparatus that generates virtual viewpoint video such that the information processing apparatus specifies a subject from among the plurality of subjects using the second data, and generates a frame image that includes the subject specified and that corresponds to the virtual viewpoint specified by the first data.

19. A data structure comprising:
first data for specifying a virtual viewpoint for a frame of a virtual viewpoint video; and
second data specifying a captured image, among a plurality of captured images obtained by capturing a subject from a plurality of positions, to be used to determine a color of a subject in the frame of the virtual viewpoint video,
wherein the data structure is used in processing by an information processing apparatus that generates virtual viewpoint video such that the information processing apparatus specifies a captured image from among a plurality of captured images using the second data, and generates, based on the captured image specified, a frame image corresponding to the virtual viewpoint specified by the first data.

20. A non-transitory computer-readable medium storing a program executable by a computer to perform a method comprising:
obtaining information designating a virtual viewpoint in a frame of a virtual viewpoint video;
obtaining information designating a subject, among a plurality of subjects, to be displayed in the frame of the virtual viewpoint video; and
outputting control information including virtual viewpoint information for specifying the virtual viewpoint for the frame of the virtual viewpoint video and setting information for specifying the subject to be displayed in the frame.
